(19) United States
(12) Patent Application Publication
(10) Pub. No.: US 2019/0244726 A1
(43) Pub. Date: Aug. 8, 2019

(54) MAXIMIZING SURFACES AND MINIMIZING PROXIMITY EFFECTS FOR ELECTRIC WIRES AND CABLES

(71) Applicant: AVERATEK CORPORATION, Santa Clara, CA (US)

(72) Inventor: Haris Basit, San Jose, CA (US)

(21) Appl. No.: 16/265,313

(22) Filed: Feb. 1, 2019

Related U.S. Application Data
(60) Provisional application No. 62/625,672, filed on Feb. 2, 2018.

(51) Int. Cl. H01B 11/02; H01B 11/00; H01B 13/02; H01B 7/30

(52) U.S. Cl. CPC H01B 11/02; H01B 7/303; H01B 13/02; H01B 11/002

(57) ABSTRACT

A cable for propagating high frequency signals comprises a first insulated hollow conductor and a second insulated hollow conductor in a braided arrangement to form the cable. The braided arrangement distributes the first and second hollow conductors such that the cable is equalized.

This application claims the benefit of priority to U.S. provisional 62/625,672 filed on Feb. 2, 2018 entitled “Maximizing Surfaces and Minimizing Proximity Effects for Electric Wires and Cables”. This and all other extrinsic references referenced herein are incorporated by reference in their entirety.

### FIELD OF THE INVENTION

The field of the invention is high frequency signal propagation.

### BACKGROUND

The following description includes information that may be useful in understanding the present invention. It is not an admission that any of the information provided herein is prior art or relevant to the presently claimed invention, or that any publication specifically or implicitly referenced is prior art.

Conducting materials with a circular cross section conduct low frequencies at a minimum conductivity per unit length by using the largest diameter wire possible for a given application. Thus, increasing the diameter of a wire by three times the original diameter increases the conductivity per unit length by a factor of nine at low frequencies, since conductivity increases as the cross sectional area of a wire increases.

As frequencies increase, an electromagnetic effect commonly referred to as the “skin effect” causes the current to flow only near the outer surface of the wire. Current flows essentially in an annulus while the center of the wire does not participate in conduction at high frequencies. The skin effect causes the vast majority of current to flow within two skin depths of the surface. The skin depth is dependent on the frequency as well as the conducting material. Thus, at higher frequencies a wire with a hollow core and a wire annulus equivalent to two skin depths in thickness has nearly the same conductivity as a wire with a solid conducting core. Further, the hollowed out conductor makes all frequencies up to skin depth frequency have a high but non-frequency-dependent resistance, which means that the hollowed out conductor is equalized.

Hollowing out the core of an electrical wire or other conductor, restricts current to the outer portion of the wire, and allows all frequencies up to the skin depth frequency to have a high, but non-frequency dependent, resistance. As a result, the hollow conductor has substantially equal resistance for all frequencies up to the skin-depth frequency. However, the downside to this approach is that the lost cross-sectional area of the hollow conductor causes increased resistance (or impedance).

Bundling hollow conductors, each with significantly smaller cross sectional areas than one larger hollow conductor, can significantly offset the higher resistance of a larger hollow conductor by increasing the cross-sectional surface area in the same amount of space occupied by a larger hollow conductor.

However, bundles of substantially parallel hollow conductors conducting high frequency signals are known to lose their advantageous properties from a high-frequency effect known as the “proximity effect.” The proximity effect forces all of the current to the outer conductors of the bundle, thereby preventing the conductors closest to the center of the cross sectional area of the bundle from contributing significantly to signal conduction.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for an apparatus and method of reducing resistance in hollow conductors for transmission of high frequency signals and reducing the proximity effect.

### SUMMARY OF THE INVENTION

The inventive subject matter provides an apparatus and a method in which bundles of hollow conductors are used to maximize the transfer of high frequency/bandwidth signals while minimizing the resistance and underutilized conducting materials.

The skin effect occurs when a high frequency electrical signal travels through a conductor which causes a majority of the current to flow through the outer surface of the wire. When using one large hollow wire, the hollow lumen of the wire does not participate in conducting any current. To utilize the empty cross-sectional area of the hollow lumen, multiple thinner hollow conductors (e.g., more than 2, more than 5, more than 10, more than 20, more than 30, more than 100, etc) can be bundled into a similar cross-sectional area as the one large hollow wire. By bundling multiple thinner hollow conductors, the cross-sectional conductive area is significantly higher than the one large hollow wire, which improves the propagation of high frequency signals through a conducting cable.

It is contemplated that the bundle of hollow conductors is braided into a litz wire arrangement to reduce the proximity effect. The proximity effect occurs when the electrical current is pushed towards the conductors closest to the outer surface of a cable. The proximity effect is especially strong when conductors are bundled in a parallel arrangement. By braiding the hollow conductors, each conductor, such as a wire, spends a substantially equal amount of time closest to the outer surface of the conducting cable, thereby reducing the proximity effect.

Non-metalized para-aramid fibers can be added to cables to increase tensile strength. In some embodiments, it is contemplated that para-aramid fibers could be used instead of a hollow lumen to provide tensile strength to otherwise hollow conductors. For example, metallizing para-aramid fibers can create conducting wires with a para-aramid fiber core. Each para-aramid fiber is preferably metalized, and the metalized para-aramid fiber is preferably insulated with an insulator, including, for example, polyimide or polytetrafluoroethylene. By using insulated fibers with a para-aramid fiber core, the claimed invention advantageously builds tensile strength into the core of the cable rather than supplementing an existing cable with non-metalized para-aramid fibers. In other embodiments, the lumens of each hollow conductor can contain a non-conductive material, such as rubber.

In conventional litz wire arrangements, every wire in the arrangement conducts current in the same direction. It is also contemplated that the claimed invention can advantageously comprise a portion of hollow conductors carrying a forward current and a remaining portion of hollow conductors carrying a return current. In embodiments with both forward current and return current carrying hollow conductors, it is contemplated that impedance is engineered by configuring the arrangement of the hollow conductors, such as by spacing them closer or farther apart or by selectively configuring each hollow conductor in a bundle to either carry a forward current, a return current, or no current. By configuring the current flow of each hollow conductor, the impedance of the system can be engineered. It is also contemplated that subgroups of hollow conductor bundles can be selectively configured to engineer the impedance of the system.

It is contemplated that conductors and assemblies of conductors as disclosed can be used to carry forward DC current, return DC current, AC currents in the same or different phases, or some combination thereof. In preferred embodiments, AC currents carried by the inventive subject matter are out of phase by at least between 170° and 180°, though it is contemplated AC currents are in the same phase, or out of phase by between 160° and 190°, 150° and 200°, 140° and 210°, or 130° and 220°.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts two cross-sectional areas of a large hollow conductor and a bundle of smaller hollow conductors.

FIGS. 2A-D are perspective views of various hollow wires braided in various litz wire configurations.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

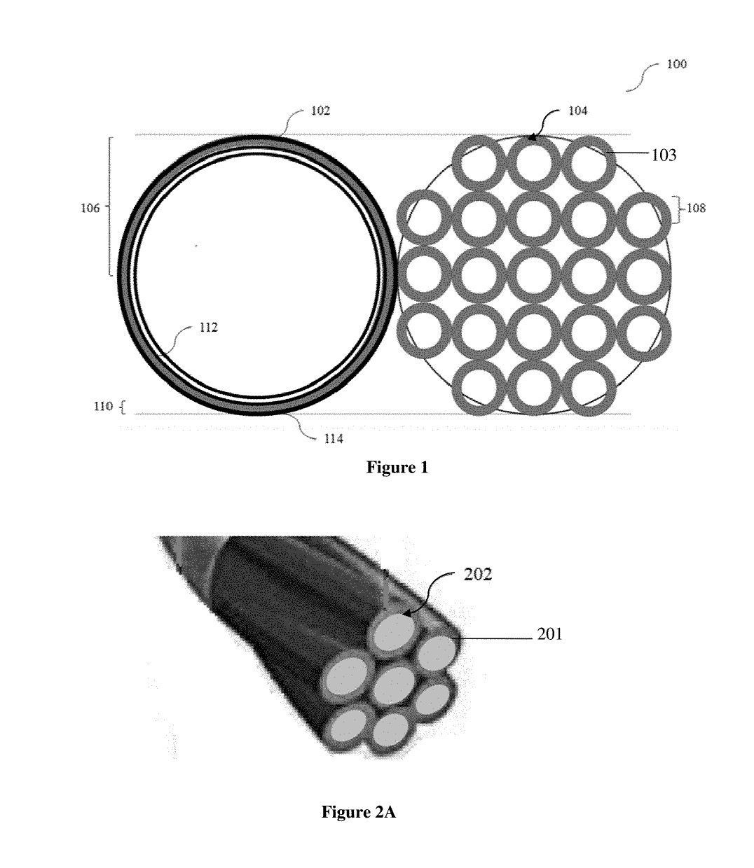

FIG. 1 depicts a cross-sectional array 100 showing a cross-sectional area of hollow conductor 102, and a cross-sectional area of bundled conductors 104.

Hollow conductor 102 transmits high-frequency electrical signals within two skin depths 110 of the outer annular surface of hollow conductor 102.

Skin depth is dependent on the frequency of an electrical signal and the conducting material. Skin depth is the depth at which the current is reduced to 37% of its surface value. Skin depth decreases with frequency. At low frequencies, the skin effect is negligible and the current distribution and resistance are virtually the same as in a direct current. This is especially true where the skin depth is larger than the diameter of the wire. As the frequency rises and the skin depth gets smaller than the wire diameter, the skin effect becomes significant. As the electrical current concentrates near the surface, the resistance per unit length of wire increases above its direct current value. Below are examples of one skin depth in copper wire at different frequencies:

At 60 Hz, the skin depth of a copper wire is approximately 8.4 mm

At 60,000 Hz, the skin depth of copper wire is approximately 0.27 mm

At 6,000,000 Hz, the skin depth of copper wire is approximately 0.027 mm

At any frequency, the vast majority of the electrical current flows within two skin depths 110 of the surface of the conducting material. An equation for measuring skin depth “δ” based on the conductive material and the frequency of the electrical signal is shown below:

$$δ = \sqrt{\frac{2 ρ}{ω μ}} \sqrt{\sqrt{1 + {( ρ ω ϵ )}^{2}} + ρω ϵ}$$

“ρ” represents the resistivity of the conductor. “ω” represents the angular frequency of the current. “μ” represents the relative magnetic permeability of the conductor and the permeability of the free space in the hollow conductor. “ε” represents the permittivity of the conductor and the permittivity of the free space.

As used herein, the term “high frequency” means where the wire radius is equal to or larger than four skin depths for a given wire. In highly conductive materials, skin depth is proportional to the square root of the resistivity, such that better conductors have reduced skin depths. Viewed from another perspective, skin depth varies as the inverse square root of permeability of the conductor. For example, the conductivity of iron is 1/7 of the conductivity of copper, but the skin depth of iron is 1/38 the skin depth of copper at 60 Hz because iron is 10,000 times more permeable than copper.

As used herein, the term “hollow conductor” means a conductor having (a) an annular region comprising a conductive material, and (b) a lumen radially bounded by the annular region, wherein the lumen contains a material other than the conductive material, for example rubber, para-aramid fiber, gas (e.g., air), or substantially or completely a vacuum

The annular region can have one or more layers that include the conductive material. Layer 112 can be an internal layer coating the lumen of the hollow conductor 102 that comprises a material other than the conductive material. Insulation layer 114 is an external layer of hollow conductor 102 comprising a substantially non-conductive insulating material.

Hollow conductor 102 preferably comprises a pure metal or a metal alloy. For example, hollow conductor 102 can comprise pure copper, a copper alloy, a silver alloy, a gold alloy, and/or non-anodized aluminum. However, hollow conductor 102 may comprise any conductive material.

Insulation layer 114 insulates hollow conductor 102 using a substantially non-conductive insulating material. For example, insulation layer 114 can comprise a rubber, a para-aramid synthetic fiber (e.g., Kevlar™), a glass, a ceramic, a polytetrafluoroehtylene (e.g., Teflon™), a paper, thermoset plastics, and/or any other rubber-like polymers. In a bundle of hollow conductors 102, each hollow conductor is preferably insulated with insulation layer 114. However, a portion of a bundle of hollow conductors 102 can be uninsulated as long as each hollow conductor 102 is not in contact with any other conductors. Insulation layer 114 preferably comprises fibers with metalized para-aramid synthetic fiber cores for a combination of strength and high heat tolerance. Layer 112 can also comprise a substantially non-conductive insulating material.

As used herein, the term “substantially non-conductive” means that a material has a resistivity (ρ) of at least 6.4×10² ohm-meters (Ω·m).

As used herein, the term “litz wire arrangement” means a specialized multi-strand wire or cable that consists of many wire strands that are individually insulated and twisted or woven together in a pattern.

In some embodiments, the hollow space of hollow conductor 102 can be filled with a non-conductive core. For example, hollow conductors 102 can be filled with fiber, rubber, a fiberglass, oil, plastic, para-aramid synthetic fiber, or any combination thereof.

Bundled conductors 104 transmit high frequency signals within two skin depths 110 of the outer annular surface of each conductor 103 in the bundled conductors 104 by using hollow conductors and also maximizing cross sectional area.

As with hollow conductor 102, each conductor 103 in bundled conductors 104 also preferably comprises a pure metal or a metal alloy and contain a hollow space within the walls of each conductor 103 among bundled conductors 104. For example, each conductor 103 in bundled conductors 104 can comprise pure copper, a copper alloy, a silver alloy, a gold alloy, and/or non-anodized aluminum. However, bundled conductors 104 may comprise any conductive material. Likewise, bundled conductors 104 can include a plurality of conductors 103 of the same composition (e.g., copper, etc) or a plurality of conductors 103 of different compositions (e.g., a mix of at least two of pure copper, a copper alloy, a silver alloy, a gold alloy, non-anodized aluminum, or other conductive material).

Likewise, the arrangement of conductors 103 in bundled conductors 104 with respect to composition, transmitting forward current, transmitting return current, or transmitting one or more channels of current can be customized to provide specific performance characteristics, such as target resistance, capacitance, inductance, impedance, current throughput, or data bandwidth. In preferred embodiments, the hollow space in each conductor 103 of bundled conductors 104 is filled with a non-conductive core. For example, each conductor 103 in bundled conductors 104 can be filled with fiber, rubber, a fiberglass, oil, plastic, para-aramid synthetic fiber, or any combination thereof. It is especially preferred that the hollow space within the walls of each conductor 103 in bundled conductor 104 contain para-aramid fibers to increase the strength of each hollow conductor 103 in the cable. The cores for each conductor 103 can be the same, or different core materials between conductors 103 in bundled conductors 104 can be used to customize performance characteristics of the bundled conductors, for example target heat resistance, insulation, tensile strength, flexibility, etc.

Each conductor 103 in bundled conductors 104 is insulated using a substantially non-conductive material, such as rubber, para-aramid synthetic fiber, glass, ceramic, Teflon, paper, thermoset plastics, and/or any other rubber-like polymers. Conductors 103 in bundled conductors 104 are preferably insulated in para-aramid synthetic fibers because of its combination of strong insulating properties and high heat tolerance. Bundled conductors 104 can also be insulated as a whole, for example a sheath of insulation around bundled conductor 104.

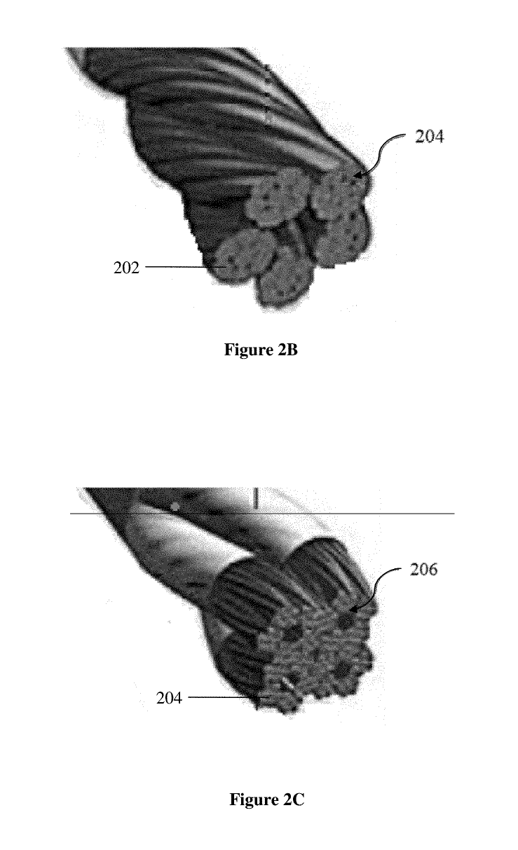

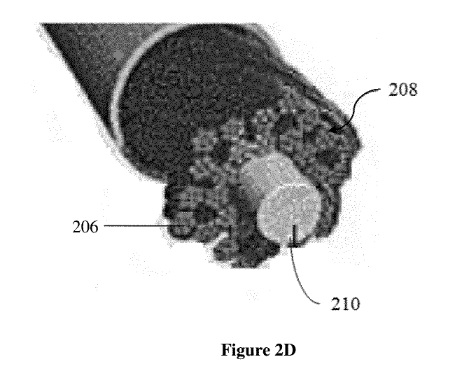

Conductors 103 in bundled conductor 104 are braided so that the proximity effect associated with high frequency electrical signals is equalized. The braiding is done so that the distance of each conductor 103 from the center of bundled conductors 104 varies. As a result, the distance between each conductor 103 and the center of the cross sectional area of bundled conductor 104 ensures that each conductor 103 spends the same amount of time at different radial distances from the center of the cross sectional area of bundled conductor 104. In a preferred embodiment, conductors 103 are arranged in bundled conductor 104 using litz wiring techniques which are discussed in further detail in FIGS. 2A-2D.

Conductors 103 in bundled conductors 104 can be configured in an alternating current arrangement. It is contemplated that a first half conductors 103 in bundled conductor 104 carries a forward current while the second half of conductors 103 in bundled conductor 104 carries a return current to create a bidirectional cable. However, bundled conductors 104 can be configured to carry any ratio of a first set of conductors 103 in bundled conductor 104 carrying a forward current and a second set of conductors 103 in bundled conductor 104 carrying a return current. It is also contemplated that the distribution of forward conductors and return current conductors can be physically distributed in configurations desired for transmitting bidirectional current, as well as transmitting multichannel current (e.g., more than 1, 2, 3, 4, 5, 10, 20, 30, or 50 streams of current insulated from each other) in one or two directions. For example, a cable containing multiple bundled conductors 104 can include concentric layers of alternating forward current bundled conductors 104 and return current bundled conductors 104 or alternating conductors 103 therein, and in some embodiments transmit multichannel currents.

Preferably, bundled conductors 104 can be configured to adjust the electrical impedance of the cable in an alternating current arrangement. In a transmission line carrying an alternating current, impedance increases as the spacing between conductors increases because the increased spacing between conductors decreases the cancellation of opposing magnetic fields. Decreasing the cancellation of opposing magnetic fields results in less parallel capacitance and more series inductance which results in a smaller current drawn by the transmission line, thereby increasing impedance. Therefore, the impedance depends on the configuration of each hollow conductor carrying either a forward or return current, such as the spacing between each conductor. However, the impedance can be adjusted in other appropriate manners known in the art.

Bundled conductors 104 have a significantly higher cross-sectional area than non-bundled conductors, such as hollow conductor 102. For example, FIG. 1 shows that hollow conductor 102 can be replaced by roughly 21 (hollow) conductors 103 in bundled conductor 104. As depicted in FIG. 1, each of the 21 conductors 103 has a radius 108 that is one-fifth the length of radius 106. As a result, the total conductive cross sectional area increases from Area 1=2πRd to Area 2=21(2π(R/5)d), which amounts to an approximately 4 times increase in the total cross sectional area available for high frequency current conduction.

Generally, a larger hollow conductor of radius R can break down into several smaller conductors of radius R/n. Specifically, approximately M=(π/4)n² smaller conductors fit in the same cross-sectional area as occupied by the larger hollow conductor. Each of the smaller conductors has a conducting cross-sectional area of A2=(2π(R/n)d). Therefore, the total conductive area of the smaller wires combined is: M*A2, which is about a 0.8n larger conductive cross section (provided that d is far smaller than (R/n). Given this formula, it is contemplated that the conductivity can increase by up to approximately 8 times by using a braided bundle of hollow wires that are each one-tenth the diameter of a larger hollow wire, while still preserving the overall size and equalization over all frequencies up to the skin depth frequency. As used herein, braided wires can also include multiple wires twisted around each other rather than in a woven arrangement.

FIG. 2A is a perspective view of a first type of litz wire in which seven hollow insulated wires 201 are individually and directly braided with each other to form primary braided wire 202. In preferred embodiments, hollow insulated wires include a core of para-aramid fibers or other non-conductive material. It is contemplated that each of hollow insulated wires 201 transmit current in one direction, though 1/7, 2/7, 3/7, 4/7, 5/7, or 6/7 hollow insulated wires transmit forward current while the other wires transmit return current. Likewise, one, some, most or all of hollow insulated wires 201 can transmit the same or different channels of current.

FIG. 2B is a perspective view of a second type of litz wire in which five sets of primary braided wire 202 are braided with each other to form a secondary braided wire 204. As with FIG. 2A, each of primary braided wire 202 can transmit current in one direction, though 1/5, 2/5, 3/5, or 4/5 primary braided wires 202 can transmit forward current while the other primary braided wires 202 transmit return current, or the same or different channels of current, or some combination thereof.

FIG. 2C is a perspective view of a third type of litz wire in which four sets of secondary braided wires 204 are braided with each other to form a tertiary braided wire 206. As above, each of secondary braided wires 204 can transmit current in one direction, though 1/4, 2/4, or 3/4 secondary braided wires 204 can transmit forward current while the other secondary braided wires 204 transmit return current, or the same or different channels of current, or some combination thereof.

FIG. 2D is a perspective view of a fourth type of litz wire in which six sets of tertiary braided wires 206 are arranged around core 210 to create a quaternary braided wire 208. It is contemplated that core 210 comprises substantially non-conductive materials, such as papers, rubbers, oils, plastics, and/or para-aramid synthetic fibers. However, core 210 may comprise any substantially non-conductive material. As above, each of tertiary braided wires 206 can transmit current in one direction, though 1/6, 2/6, 3/6, 4/6, or 5/6 of tertiary braided wires 206 can transmit forward current while the other tertiary braided wires 206 transmit return current, or the same or different channels of current, or some combination thereof.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A cable for propagating high frequency signals with reduced dispersion and distortion, the cable comprising a first insulated hollow conductor and a second insulated hollow conductor, coupled in a braided arrangement.

2. The cable of claim 1, wherein para-aramid synthetic fibers occupy lumens of each of the first and second insulated hollow conductors.

3. The cable of claim 1, further comprising a plurality of insulated hollow conductors, wherein the plurality of insulated hollow conductors, the first insulated hollow conductor, and the second insulated hollow conductor are coupled in a litz wire arrangement.

4. The cable of claim 1, wherein the first insulated hollow conductor carries a forward DC current, and concurrently the second insulated hollow conductor carries a return DC current.

5. The cable of claim 1, wherein the first insulated hollow conductor carries a first AC current, and concurrently the second insulated hollow conductor carries a second AC current, and wherein the first and second AC currents are out of phase by an amount between 170° and 180°.

6. The cable of claim 1, wherein a first lumen of the first insulated hollow conductor contains a first core of a non-conductive material.

7. The cable of claim 6, wherein a second lumen of the second insulated hollow conductor contains a second core of the non-conductive material.

8. The cable of claim 1, wherein a spacing between the first and second insulated hollow conductors is selected to obtain a desired impedance to current flowing within at least part of the cable.

9. The cable of claim 1, wherein the first insulated hollow conductor (a) comprises an annular region having a conductive material, and (b) defines a lumen radially bounded by the annular region, and wherein the lumen contains a material other than the conductive material.

10. A method of creating a conducting cable for propagating high frequency signals with minimal dispersion and distortion, comprising:
calculating a desired number of small hollow conductors that fit into a cross-sectional area of a large hollow conductor; and
braiding the small hollow conductors into a bundle.

11. The method of claim 10, wherein para-aramid synthetic fibers occupy lumens of each of the small hollow conductors.

12. The method of claim 10, wherein the bundle is organized a litz wire arrangement.

13. The method of claim 10, wherein a first one of the small hollow conductors carries a forward DC current, and a second one of the small hollow conductors carries a return DC current.

14. The method of claim 10, wherein a first one of the small hollow conductors carries a first AC current, and a second one of the small hollow conductor carries a second AC current, wherein the first and second AC currents are out of phase by an amount between 170° and 180°.

15. The method of claim 10, wherein a first lumen of a first one of the small hollow conductors contains a first amount of a non-conductive material.

16. The method of claim 15, wherein a second lumen of a second one of the thinner hollow conductors contains a second amount of the non-conductive material.

17. The method of claim 10, further comprising spacing apart a first and a second of the small hollow conductors to provide a desired impedance to current flowing within the bundle.

18. The method of claim 10, wherein each of the small hollow conductors comprises (a) an annular region having a conductive material, and (b) defines a lumen radially bounded by the annular region, and wherein the lumen contains a material other than the conductive material.
